(19) United States
(12) Patent Application Publication
(10) Pub. No.: US 2024/0185516 A1
(43) Pub. Date: Jun. 6, 2024

(54) A Method for Integrated Gaze Interaction with a Virtual Environment, a Data Processing System, and Computer Program

(71) Applicant: Legind Von Bergen Holding ApS, Værløse (DK)

(72) Inventor: Klaes Bergen, Værløse (DK)

(21) Appl. No.: 18/285,155

(22) PCT Filed: Mar. 31, 2022
(86) PCT No.: PCT/EP2022/058625

§ 371 Date: Sep. 29, 2023

(30) Foreign Application Priority Data
Mar. 31, 2021 (EP) 21166418.0

(51) Int. Cl. G06T 17/00; G02B 27/01; G06F 3/01; G06V 40/20

(52) U.S. Cl. CPC G06T 17/00; G02B 27/0172; G06F 3/013; G06F 3/014; G06V 40/23

(57) ABSTRACT

A method for integrated gaze interaction with a virtual environment, the method comprising the steps of: receiving a gaze activation input from a user to activate a gaze tracker, defining a first position in the virtual environment based on gaze tracker user input, defining a working area adjacent the first position as only a part of the virtual environment, and operating the virtual environment within the working area only, by a first user input from at least one input device different from the gaze tracker.

The disclosure relates to a method for integrated gaze interaction with a virtual environment.

### BACKGROUND

Eye Tracking as an interaction input modality offers fast target homing. However, it is limited in terms of precision and comes with substantial cost to the user's vision resources, if eyes are to be committed to performing actions outside of a normal observational scope.

U.S. Pat. No. 10,860,094 describes how to use a gaze-tracking system for controlling a cursor on a screen. The gaze tracking system constantly calculates a gaze of a user using a lot of computational power. The position of the cursor is used as a start-point for the next position of the cursor, so that the cursor is moved to the gaze area on the screen if the cursor is moved towards that area. If the direction of the movement of the cursor towards the gaze area is not close enough the cursor will not be moved, and the user has to try again, and movements towards the gazed upon area may elicit undesired cursor repositioning.

Within the concept of the present disclosure, the term lamp is supposed to be understood to represent any electrical item that can be turned on and off and/or be electronically manipulated, like e.g. a television, where e.g. a channel shown by the television, volume or contrast can be manipulated, or a radio, or a ceiling lamp, a table lamp, floor lamp, wall lamp, etc.

Within the concept of the present disclosure, the term camera is supposed to be understood to
comprise a camera or two cameras working together, which is/are integrated in a smartphone, or stand alone, and may contain a digital display.

Within the concept of the present disclosure, the term smartphone is supposed to be understood to
comprise any portable computer or mobile computing device with camera(s) e.g. for gaze tracking, and e.g. an integrated screen, wherein the smartphone preferably has a size so that the smartphone can be positioned in a pocket like a coat pocket or a trouser pocket,
be a portable unit or mobile computing device comprising camera(s) e.g. for gaze tracking, and e.g. an integrated screen, but where the portable unit does not have computational power for processing received information from the camera(s), but where the received information is transferred to another computer, e.g. a cloud computing service or desktop pc, which will process the information and perform calculations involved for performing the method of the disclosure, and/or
be any portable unit or handheld unit comprising camera(s), with or without computational power for processing received information from the camera(s), with or without a transmitter for wireless or wire-based transfer of the information from the camera(s) to a computer or processing unit for processing the received information and for controlling the virtual environment and reality like e.g. a lamp connected to the virtual environment, and with or without the ability to call other phones.

Within the concept of the present disclosure, the term computer is supposed to be understood to represent any stationary or mobile computer, stationary or mobile computer system, stationary or mobile computing device, or stationary or mobile remote computer system.

### SUMMARY

Considering the prior art described above, it is an objective of the present disclosure to faster, easier and more reliably move the cursor to the relevant area on the screen with reduced computational power usage, enhanced energy savings and easier, faster and more reliable control/human computer interaction.

It is also an objective of the present disclosure to easily and effectively control electrical items even from a distance.

The objective can be achieved by means of a method for integrated gaze interaction with a virtual environment, the method comprising the steps of:
receiving a gaze activation input from a user to activate a gaze tracker,
defining a first position in the virtual environment based on a gaze tracker user input as determined by the gaze tracker,
defining a working area adjacent the first position as only a part of the virtual environment, and
operating the virtual environment within the working area only, by a first user input from at least one input device different from the gaze tracker.

Thus, it is possible to activate the gaze tracker only when the gaze tracker is to be used at an interaction. No or very little computational power is wasted, when the gaze tracker is not needed. In addition or alternatively, each time when the gaze activation input is received, the information about the position and direction of the eyes of the user is registered by the gaze tracker so that the first position can be defined based on the gaze tracker user input. Between two gaze activation inputs the gaze tracker does not need to be switched off. No computational power needs to be wasted on any signal from the gaze tracker between two gaze activation inputs. The gaze tracker user input can be input about the position and direction of the eyes of the user from the user that is registered by the gaze tracker.

The working area is limiting the operation in the virtual environment to the area of interest. The eyes can move fast over the screen and activate or make available for interaction what the user considers of importance. The advantage is that the user can move the working area or the area of interest around within the virtual environment very fast. That means that the user is able to perform many more tasks per unit time. That is e.g. advantageous when working in two different windows, where the user has to put in some information in one window and then put in some information in the other window, etc.

If the defined working area accidentally does not cover the area, which the user intended to operate, the user can easily send a new gaze activation input for defining the first position and the working area again.

That the working area is adjacent the first position means that the first position is at least within the working area.

The gaze tracker can be configured for tracking, where on or in the observed (virtual or real) environment eyes of the user are directed. The gaze tracker can comprise one or two first cameras for continuously (when the gaze activation input has been received) capturing images of one or both eyes of a user.

The first camera can be integrated in a computer or a computer screen or a smartphone, or an external first camera positioned e.g. on top of a computer or a computer screen. The first camera can also be positioned on the inside of goggles or glasses for detecting and/or tracking the gaze when the goggles or glasses are worn by the user.

The first user input can be pressing a certain button, or the user performing a certain movement in front of a camera, e.g. one or two first cameras, connected to the computer, wherein the certain movement is identified via for example a video based motion capture solution. A software on the computer can be configured for recognizing different movements by a user and connecting each movement to a certain command, like e.g. the gaze activation input, and/or a deactivation input for terminating the step of operating the virtual environment and/or different commands for operating the virtual environment.

The movements can be certain movements by an arm, a hand, a leg, a foot, or a head. The arm, the hand, the leg, the foot, or the head can be wearing a wearable or a wearable input device for enhancing the sensitivity of the movement recognition so that the software more easily can register the different movements and part the different movements from each other.

The virtual environment may be controlled by a computer, processor or processing device comprising a trackpad for controlling the virtual environment, and/or connected to a wearable for receiving input from a body member wearing the wearable, for controlling the virtual environment and/or connected to a camera for registering movements by a user for controlling the virtual environment, and/or connected to an electromyograph or a neural and/or muscle activity tracker for receiving input from a body member wearing the electromyography or the neural and/or muscle activity tracker for controlling the virtual environment.

If the working area turns out not to be where the user intended the working area to be, the step of operating the virtual environment within the working area only can be providing a first unique input to the software like e.g. a special key or a special combination of keys of the keyboard or a special clicking combination on the trackpad like e.g. a triple click or more or a double click with two or more fingers, that will enable the working area to be moved on the screen to where the user want the working area to be. When the first unique input has been received by the software, the user can move the working area by moving one or more fingers on the trackpad or by using a certain key like e.g. a key with an arrow, the gaze tracker input may be used in the process of moving the working area.

A data processing system may be configured for receiving the instructions from the user and for performing the steps as presented in the present disclosure.

That the gaze activation input from the user activates the gaze tracker can mean that the gaze tracker is switched on from a switched off state.

That the gaze activation input from the user activates the gaze tracker can mean that the gaze tracker is changed from an idle mood—where the gaze tracker is just waiting for instructions to get active and/or where the gaze tracker is in a battery or power saving mode—to an active mood, where the gaze tracker is able to track the gaze of the user and transmit information about the first position to a processor configured to perform the steps of the method.

That the gaze activation input from the user activates the gaze tracker can mean that the gaze tracker is changed from not transmitting to transmitting the information about the first position to the processor. The gaze tracker may be in an active mode all the time, but the gaze activation input will activate the transmittance of the first position to the processor.

That the gaze activation input from the user activates the gaze tracker may be changed from not processing received gaze tracker data sent to memory by the gaze tracker, to processing the data sent to memory.

The working area can alternatively or additionally be understood to mean a working volume, wherein the virtual environment can be operated within the working volume in three dimensions. A camera, that may be the gaze tracker, may determine the positions or the relative position/rotation of the eyes of the user for determining the focal length of the eye(s)—where the user has the focus of the eyes. The working volume can be limited in the depth direction by less than +/−5 m, or less than +/−4 m, or less than +/−3 m than around the determined focal length, which is especially suitable when the focal length is far away from the user, like e.g. 10 m away or e.g. more than 10 m away. Alternatively, when the focal length is far away from the user, like e.g. 10 m away or more than 10 m away, the working volume can be limited to stretch from 5 m from the user to infinity, or 6 m from the user to infinity, or 7 m from the user to infinity.

The working volume can be limited in the depth direction by less than +/−3 m around the determined focal length, or by less than +/−2 m around the determined focal length, which is especially suitable when the focal length is not so far away from the user, like e.g. between 5 m and 7 m away. The working volume can be limited in the depth direction by less than +/−1 m around the determined focal length, which is especially suitable when the focal length is not far away from the user, like e.g. between 2 m and 5 m away. The working volume can be limited in the depth direction by less than +/−0.5 m around the determined focal length, which is especially suitable when the focal length is close to the user, like e.g. less than 3 m, or less than 2 m.

Different users can have different relative positions of the eyes for the same focal length; i.e. the user can have strabismus, where the eyes are not properly aligned with each other when looking at an object. For that reason the system can be trained for determining the focal length of a new user by comparing the relative positions of the eyes when the user is looking at objects, which are positioned at different distances, which are known to the system, away from the eyes of the user.

That the gaze tracker is only active when the gaze activation input is received means that continuous gaze data processing is not needed, which decreases energy/computational resource requirements. That the gaze tracker is only active when the gaze activation input is received means strong privacy for the user, no third party may acquire information about what the user is looking at because there is no such information, and the only information available is the first position/working area as well as a possible cursor position.

The method will make it faster, easier and more reliable to operate a virtual environment, e.g. using a cursor. The working area itself can enable manipulating the virtual environment directly (e.g. if there is only one object, like a lamp icon controlling a real lamp, in the virtual environment, cursor manipulation may be omitted and a button press, tap or gesture may suffice to manipulate the object, like switching on or off the lamp.

The working area itself can enable manipulating the virtual environment indirectly, by selecting a single object or a single group of objects within a working area, and/or by modifying the selected single object or the selected single group of objects. Using the present method it is not necessary to move the cursor far in the virtual environment anymore; only precise short manipulation of the cursor is necessary.

The gaze tracker can be installed in a vehicle for tracking the gaze of a driver of or a person in the vehicle. The vehicle may have windscreen and/or a window, and a steering wheel. The steering wheel can have a first steering wheel button and a second steering wheel button, and maybe a third steering wheel button. Alternatively, the first steering wheel button and/or the second steering wheel button and/or the third steering wheel button is/are not positioned on the steering wheel but somewhere else in the vehicle, preferably at a convenient location within reach of the driver or the person.

Pressing the first steering wheel button and/or the second steering wheel button or the third steering wheel button can be the gaze activation input for activating the gaze tracker.

The windscreen or the window may comprise a first area, a second area, a third area, etc., wherein the first area is e.g. connected to controlling the temperature of the heating system, wherein the second area is e.g. connected to controlling the fan speed of the heating system, wherein the third area is e.g. connected to controlling the volume of the audio system, etc., so that when the first position is defined within the first area, and the working area is defined inside or around the first area, the user can control the temperature of the heating system by using the first steering wheel button and the second steering wheel button. The first steering wheel button and the second steering wheel button can be the input device.

When first position is defined within the second area, and the working area is defined inside or around the second area, the user can control the fan speed of the heating system by using the first steering wheel button and the second steering wheel button, etc.

The vehicle may comprise a first lamp in the first area, a second lamp in the second area, a third lamp in the third area, etc. so that the first light will light up when the first position and the working area is defined with the first area, etc. In the example provided above, the first lamp could preferably be illuminating a text reading “temperature”, etc.

A head-up display could display the selected item, like temperature, fan speed, volume, radio channel, etc., which has been selected by the gaze tracker for being controlled.

Alternatively, the item selected by the gaze tracker can also be not disclosed to the driver or person. That will be a cost-effective solution. Since the gaze tracker can be so precise in the determination of the gaze of the user, the user will know that the user has gazed at the first area for determining the temperature.

When controlling a lamp or lamps in a room, the user does need to be presented, which lamp has been selected by the gaze and the gaze tracker. The user can switch on and off the lamp anyway, e.g. by using an input device in a smartphone held by the user.

In an embodiment, the step of defining the first position can deactivate the gaze tracker. Deactivating the gaze tracker can mean to turn the gaze tracker off or to change a status of the gaze tracker, so that the gaze tracker is not registering a gaze of the user. Deactivating the gaze tracker can mean that the gaze tracker is registering a gaze of the user, but is not transmitting any information about the gaze of the user. In all of these cases, the privacy of the user is protected, since information about the gaze of the user is only used at the commend by the user to define the first position and the working area, and when the first position is defined, the gaze tracker is deactivated.

In an embodiment, the gaze activation input can be received from the at least one input device. The advantage is that operation of the virtual environment is made easier, since the same device is receiving the gaze activation and is operating the virtual environment within the working area only. The user only needs to operate one device.

In an embodiment, the method can comprise the steps of: receiving a second gaze activation input from the user to activate the gaze tracker, defining a second position in the virtual environment based on a second gaze tracker user input, and defining a second working area adjacent the second position as only a part of the virtual environment, wherein the method further comprises the steps of: returning to the working area, and operating the virtual environment within the working area only, by the first user input from the at least one input device different from the gaze tracker, or wherein the method further comprises the step of operating the virtual environment within the second working area only, by the first user input from the at least one input device different from the gaze tracker. This embodiment presents two alternatives.

The user may accidentally activate or may regret having activated the gaze tracker for defining the first position. The user may then instruct e.g. the data processing system to go back to the working area by sending a regret input by e.g. pressing a button or perform a certain movement in front of the camera connected to the computer or perform a certain movement by a hand wearing a wearable, such as a dataglove, connected to the computer comprising a software that can be configured for recognizing different movements by the wearable and connect at least some of the movements to certain commands.

Whether the first mentioned alternative or the second mentioned alternative of the two alternatives will be the selected one may depend on a duration of the second gaze activation input or the input performed after the gaze the gaze activation input. If the duration of the second gaze activation input is shorter than a predefined time period, the first alternative is chosen, otherwise the second alternative is chosen. Alternatively, if the duration of the second gaze activation input is longer than a predefined time period, the first alternative is chosen, otherwise the second alternative is chosen.

Whether the first mentioned alternative or the second mentioned alternative of the two alternatives will be the selected one may depend upon an interaction input that is performed after and/or in extension of the gaze activation input, e.g. a time duration based interaction like a tap, or a scroll input, or an input type or some input types that is repetitive or for some other reasons would not necessarily require visual confirmation from the users perspective to use, the first alternative may be chosen, otherwise the second alternative is chosen. As a consequence, a gaze input followed by a time duration of no completed gestures or a completed gesture, like pressing a button or performing an input type that would likely require visual confirmation from the user to use, can signal the second alternative.

As such, an input e.g. a gesture performed on a trackpad or in front of a camera may not only be an input that performs a function on a virtual environment object but may also contain information that directly informs the system to use a first working area instead of a second.

In an embodiment, the method can comprise the steps of: receiving a second gaze activation input from the user to activate the gaze tracker, receiving an interruption input from the user to deactivate the gaze tracker, returning to the working area, and operating the virtual environment within the working area only, by the first user input from the at least one input device different from the gaze tracker.

In case touching the trackpad is used for activating the gaze tracker, but the user wants to use the trackpad for something else than defining the working area, the user can touch the trackpad, which will activate the gaze tracker, but e.g. by sliding the finger on the trackpad preferably within a certain time limit like 75 ms or 200 ms, the sliding of the finger can be considered an interruption input, so that the first position and the working area is not defined again. This way the trackpad can be used and still the old working area can be used.

In an embodiment, the gaze activation input can be received from the at least one input device.

That the user can activate the gaze tracker for defining the first position and operate the virtual environment using the same input device means that controlling the virtual environment can be performed much faster and easier. The cursor can be controlled faster and easier by the user, and the procedure how to activate the gaze tracker can be learnt much faster by the user.

In an embodiment, a cursor of the virtual environment can be moved to within the working area when the first position has been defined.

To move the cursor only by an electronic mouse, a touchpad/trackpad, a touchscreen, a trackball, etc. is a slow way of moving the cursor. The eyes move much faster over a screen. The mouse, trackpad, touchscreen, trackball, etc. can in addition cause repetitive strain injuries and/or discomfort. When using a trackpad and keyboard based embodiment, using the present disclosure will require hardly any movement of the hands away from the keyboard/trackpad for executing desired interactions. Both hands can be continuously kept on the keyboard in a resting position, which will be a very ergonomic solution. In addition, no unnecessary movements of the hands away from the keyboard are necessary.

If the cursor happens to already be inside the working area when the working area is defined, the cursor will not necessarily be moved. That will avoid unnecessary moving around of the cursor within the virtual environment.

The virtual environment can be the virtual environment shown on a display device, such as a computer screen or another display, where the working area can be a certain part of the virtual environment shown on the display device.

The virtual environment can be virtual reality, where the reality is recorded by e.g. a camera and shown on a display device together with virtual objects, which can be positioned at a certain position in the virtual reality space. The camera and the display device can be a camera and a display device of a mobile unit, such as a smart phone or a head-mounted display, such as a virtual reality headset.

The display device can also be transparent like e.g. an optical head-mounted display, where the user can see the reality through and not necessarily on the display device. The virtual objects shown on the transparent display device may be positioned at certain positions in the virtual reality space, in which case a camera may be necessary for informing the virtual reality space which part of the reality the user is watching. The virtual objects shown on the transparent display device may be positioned at certain positions on the display device even when the user is moving around, so that the virtual objects are not positioned at certain positions in the virtual reality space.

In an embodiment, operating the virtual environment can comprise at least one of the steps of moving the cursor within the working area and/or scrolling an application window or application slide, and/or zooming an application window or application slide, and/or swiping from a first window or a first slide to a second window or a second slide, and/or activating or deactivating checkboxes, wherein the input can be tapping, clicking, and/or touching, and/or selecting radio buttons, wherein the input can be tapping, clicking, and/or touching, and/or navigating and selecting from dropdown lists, wherein the input can be tapping, clicking, scrolling and/or touching, and/or navigating, and activating and/or deactivating items from list boxes, wherein the input can be tapping, clicking, scrolling and/or touching, and/or clicking a button or icon in the virtual environment, wherein the input can be tapping and/or clicking, and/or clicking a menu button or menu icon for activating a drop down, a pie menu, and/or a sidebar menu, wherein the input can be tapping and/or clicking, and/or activating and deactivating toggles, wherein the input can be tapping, clicking, scrolling and/or touching, and/or manipulating text fields, wherein the input can be tapping, clicking, swiping, scrolling, dragging, dropping, and/or touching, and/or manipulating windows, fields and message boxes, wherein the input can be tapping, clicking, swiping, scrolling, dragging, and/or dropping, and/or manipulating sliders, track bar and carousels, wherein the input can be tapping, clicking, swiping, flicking, scrolling, rotating, dragging, and/or dropping, and/or activating and deactivating tool tips, wherein the input can be cursoring over, tapping, clicking, swiping, and/or scrolling.

The application window or in normal language just a window can mean a graphical control element for computer user interactions, where the application window can consist of a visual area containing a graphical user interface of the program, to which the window belongs.

The application slides or just the slides can be a series of slides of a slide show for presenting information by its own or for clarifying or reinforcing information and ideas presented verbally at the same time.

The application window or the application slide can be scrolled, swiped or zoomed out of or into e.g. by activating a gaze tracker, defining a working area adjacent a first position, and activating the application window or the application slide e.g. by moving the cursor to within the application window or the application slide and optionally pressing a button, so that a certain command connected with scrolling, swiping or zooming in/out will scroll, swipe or zoom in/out the window or slide.

The certain command connected with scrolling may be moving two body members, like two fingers, in the scrolling direction as is the custom within the field. The certain command connected with swiping may be moving one body member, like one finger, in the swiping direction as is the custom within the field. The certain command connected with zooming is preferably made by two body members, like two fingers, moved away from each other (zooming in) or moved towards each other (zooming out) as is the custom within the field. The certain command can e.g. be performed in the air in front of a camera that is configured for interpreting the movement and for controlling the virtual environment based on the certain command, and/or performed with the body member(s) wearing a wearable, such as a dataglove, worn by a hand, that is configured for registering and interpreting the movement and for controlling the virtual environment based on the certain command.

In this way scrolling, zooming, swiping can be performed by one single hand.

A small scrollbar can be controlled without a finger. When a small item comprising few pixels is manipulated by a finger pressing on a touchscreen, the finger can have the disadvantage that the finger is in the way and hinders the user to see what exactly is manipulated. The user may have to try several times before the finger is touching the correct pixel(s) and the desired operation can be performed. Without having to use a finger, objects like e.g. a scrollbar can be made smaller and the user will still be able to easily manipulate and control the virtual environment.

Without having to use a finger for controlling objects, like e.g. a scrollbar, on the display the touch screen can be significantly reduced, which will make e.g. a smart phone more cost effective and to use less power, extending the battery life, while providing expanded interactive functionality.

The touch screen part of the screen could be made to just cover a small area of the smart phone screen for providing track-pad equivalent input support, or a part of the bottom of the smartphone screen for providing the normal keyboard functionality as well, this would reduce the need for capacitance functionality screen coverage by at least 60%.

Swiping can mean moving one application window or application slide out of the working area and receive another application window or application slide within the working area.

That the cursor can be moved within the working area only means that the cursor cannot accidentally be moved far away from the area of interest so that the user has to send a new gaze activation input for activating the gaze tracker. The user will save time and the interactions with the gaze tracker and/or the at least one input device, can be simplified, more robust and faster, thus improving user friendliness and experience.

User Interface (UI) elements can be formalized virtual objects that can serve defined purposes. Generalized objects may also receive input via the same sources and inputs or input types, but may have unique behaviours associated with these inputs. The input types typically given are from the in-exhaustive list of: performing a gesture, performing a tap, performing a cursor over, or performing a button press or hold, performing a touch input, using a rotary encoder, using a joystick or using slider/fader, these inputs are then interpreted as some concrete input type, this type is then sent to the object(s) that are defined as recipients from the working area cover, cursor over target and/or system state (any active selection, for example from a box selection of icons). When a recipient receives one of these input types, the recipient then may execute some behaviours like an application window receiving a scroll may, simply moving along the display text, while a 3D model may be rotated by e.g. scrolling.

Of the mentioned inputs, gestures, but also taps may have distinct sub-types: tapping one, two, three or more times, tapping one, two, three or more times followed by dragging an object by sliding finger, tapping followed by flicking, pressing harder than a certain pressure limit, pressing softer than a certain pressure limit, sliding by one, two, three, or more fingers for scrolling, for swiping, or for flicking, pinching two or more fingers for zooming in, spreading two or more fingers for zooming out, rotating two or more fingers for rotating a selection, shaking or wiping two, three or more fingers for cancelling, undoing and/or clearing an earlier command, and/or drawing of a certain symbol for pausing screen.

Holding a smartphone by one hand and controlling the touchscreen of the smartphone with the same hand means due to the size of most smartphones that to reach the whole touchscreen is difficult, if not impossible. A button positioned in such a difficult-to-reach area will cause problems if the button is to be activated. By only having a part of the screen as a touch screen, not only is the costs for producing the smartphone reduced, but the whole touchscreen is within reach of a finger, normally a thumb, that is used for controlling the smartphone.

If the working area is defined around a button to be pressed, the button can be moved to within the touchscreen part of the screen and within reach of the finger and the button can easily be activated.

Alternatively, the working area may be defined around a button to be pressed, and the button may be selected. The user may activate the button by e.g. tapping the touchscreen or sliding on the touchscreen, etc. even if the touchscreen is outside the working area, since the virtual environment is operated within the working area only.

In yet another alternative, if the working area is defined around a button to be pressed, but the working area also comprises other buttons, the user can move the cursor to the button to be selected and activate the button as mentioned above. The user can move the button by sliding e.g. a finger on the touchscreen, where the cursor being within the working area will move as the finger moves on the touchscreen but offset, where the finger is moving on the touch screen outside the working area and the cursor moves within working area. An advantage is that the selection can be much more precise, since there is no finger covering the cursor obstructing the user to see what is selected. The icons and the distances between icons can be made smaller and shorter, respectively.

In a fourth alternative, if the working area is defined around a button to be pressed, but the working area also comprises other buttons, the user can move the selection from one to button to another button by e.g. tapping the touchscreen until the button to be activated is selected. Another command like e.g. a double tapping on the touchscreen may then activate the button. The icons and the distances between icons can be made smaller and shorter, respectively.

In an embodiment, at least one movement by a body member like an eyelid, a hand, an arm, or a leg of the user can be registered by a camera or by the camera for operating the virtual environment.

The camera can be connected, e.g. wirelessly connected, to the computer, which may comprise a software that can be configured for recognizing different movements by the user in front of the camera and for connecting each movement to a certain command in the virtual environment. By performing a certain movement in front of the camera, a certain command can be performed in the virtual environment. The camera can be the first camera.

In an embodiment, different relative movements or different relative positions between a first finger and a second finger of a hand and/or a first finger and a palm of a hand can be registered by a wearable, such as a dataglove, worn by the hand for operating the virtual environment.

In an embodiment, different relative movements or different relative positions between a first body member and a second body member of a body member and/or a first body member and a landmark of a body member can be registered by a wearable worn by the body member for operating the virtual environment.

The dataglove can be connected, e.g. wirelessly connected, to the computer, which may comprise a software that can be configured for recognizing different movements by the dataglove and for connecting each movement to a certain command in the virtual environment. By performing a certain movement by the dataglove, a certain command can be performed in the virtual environment.

The wearable can also be for a foot, or for a neck, or for an elbow, or for a knee, or another part of a body of the user. Depending on the wearable and by what body member the wearable is supposed to be worn, the different relative movements or different relative positions can be between different toes of the foot, between one or more toes and the rest of the foot, between the foot and the leg, between a head and a torso, between an upper arm and a lower arm, between a thigh and a leg.

These movements positions of the fingers and of the first finger and the palm can also be detected and/or determined using the camera.

In an embodiment, operating the virtual environment can comprise the first finger touching different areas of the second finger or the palm. By a fingertip of the first finger touching the second finger or the palm at different positions, different commands can be sent to the virtual environment. Instead of touching the second finger, the first finger can also touch different positions of a third or a fourth or fifth finger, so that at least 12 commands can be connected to the first finger touching different positions of the second, third, fourth and fifth fingers. The first finger can be the thumb. The virtual environment can be controlled in very many ways.

In an embodiment, the cursor can be positioned inside the working area in a second position determined by a position of a first body member of the user relative to a coordinate system or by where on a trackpad a finger of the user is resting.

The first body member can be an eyelid, a hand, an arm, or a leg of the user, which movements or positions can be registered by a camera.

If e.g. the finger is resting on the trackpad in the right corner of the trackpad closest to the user, the second position will logically be in the lower right end of the working area on the screen. Likewise, if the finger is resting on the trackpad in the left side of the trackpad in the middle section of the trackpad seen from the user, the second position will logically be in the left side, middle section of the working area on the screen. Of course, the relation between the second position within the working area and the position of the finger on the trackpad does not need to be based on a direct trackpad position to working area position mapping logic and can be a complex relation, however an intuitive relation will be more user friendly. The working area can have one shape and the trackpad another but it will be more user friendly if the shape of the working area is adapted to the shape of the trackpad. If the trackpad is round, the working area is preferably round and if the trackpad is square or rectangular, the working area is preferably square or rectangular. How exact the second position can be determined depends on the resolution of the trackpad and the relation to the display/virtual environment coordinate system.

The advantage of being able to control the second position is that the gaze tracker may not determine the gaze of the user totally correctly so that the working area is not centred around the point, at which the user was actually looking. When looking at one side of the screen, the working area may be a little offset in the right direction and when looking at the other side of the screen, the working area may be a little offset in the left direction. The user will learn after a while if there are any consistent offsets of the working area, and can then correct for the offsets by determining the second position so that the cursor is very close or on the spot on the screen, to where the user intended the cursor to be moved. The time it will take to move the cursor to the correct position on the screen will be even shorter, and there will be even less strain on the joints and tendons of the arm and hand of the user.

In an embodiment, the coordinate system can be defined by a tracking device, like a trackpad, or a first part of a wearable like a dataglove worn by a second body member of the user, or the second body member of the user as seen by a camera, or a first signal from an electromyograph or a neural and/or muscle activity tracker worn by a second body member of the user, where the first signal is a nerve signal and/or a muscle signal for moving a certain body member.

The coordinate system can be a track pad, so that the position of the first body member like a finger or a toe on the track pad will determine the second position. The touch sensitive 2D surface of the trackpad can define the coordinate system, so that if e.g. a finger is touching the trackpad at the position of e.g. 2 o'clock the cursor will be moved to the position of 2 o'clock in the working area.

The first part of the data glove can be the palm, to which the movements of all the fingers and the thumb will relate.

The coordinate system can be a palm of a hand of a user, so that the position of the first body member like a finger or thumb in relation to the palm will determine the second position. A dataglove can be connected to the computer for transferring the information about the relative position of the first body member and the palm so that the correct command can be extracted from the user.

The coordinate system can be a torso of a user, so that the position of the first body member like an arm or a leg in relation to the torso will determine the second position. A camera recording the user can determine the relative position of the first body member and the torso.

The coordinate system can be an eye opening of an eye of a user, so that the position of the first body member like a pupil of the eye in relation to the eye opening will determine the second position. A camera of glasses or goggles may have a camera looking at an eye of the user can preferably determine the relative position of the pupil and the eye opening.

The second body member can be the torso as the coordinate system to which the movements of the arms, legs, and head will relate. The positions of the arms, legs, and head in relation to the torso can be monitored by the camera, which sends the information to a/the computer, which comprises a software that can translate the positions to a command to be executed.

A person, who has lost e.g. a hand, will still be able to send nerve signals for controlling the hand and fingers even though the hand and the fingers are lost. The electromyograph or the neural and/or muscle activity tracker is able to sense the nerve signals and/or the muscle signals so that the user can send a nerve signal or a muscle signal for moving a finger that corresponds to the gaze activation input, and the nerve signal can be registered by the electromyography or the neural and/or muscle activity tracker, so that the gaze tracker is activated.

In an embodiment, the first body member and/or the second body member can be selected from the group of a finger, or a hand, a palm, an arm, a toe, a foot, a leg, a tongue, a mouth, an eye, a torso and a head. A person missing e.g. hand can still use an arm and effectively control the virtual environment.

In an embodiment, the first body member and/or the second body member can be wearing a wearable, wherein the wearable is configured for determining a position of the first body member and/or the second body member and/or a relative position of the first body member relative the second body member.

In an embodiment, the first three steps of claim 1 can be performed twice for defining a first working area and the working area, wherein the first user input operates the virtual environment based on the first working area and the working area.

In a first performance of the first three steps of claim 1 the first working area is defined and in a second performance of the first three steps of claim 1 the working area is defined.

To keep order of the files and programs in a computer, the files and programs are organised in directories, where the files, programs and directories appear as icons with different appearances on the computer screen. If the user wants to select two icons in a computer screen the user can gaze at a first icon of the two icons for defining the first working area and selecting the one of the two icons. By providing a second unique input to the software that will keep the selection of the first icon and by gazing at a second icon of the two icons for defining the working area and selecting the second icon both icons can be selected. Alternatively, the second unique input can instruct the software to select all icons within a rectangle with two opposite corners in the first working area and in the working area, respectively. The corners in the first working area and in the working area, respectively, are preferably marked each time. Instead of a rectangle, icons are selected within a circle or some other shape, where edge(s) of the circle or the other shape is defined by the first working area and the working area.

Instead of selecting icons, the second unique input can inform the software that the marked icon(s) in the first working area should be moved to the working area.

Instead of icons, text in a word processor application or drawings or parts of drawings in a drawing editor can be selected or moved in the same way.

In most operating systems each opened file will be presented in a window with a frame around. The windows can be moved around and if the window cannot show all the information, the window can be scrolled down and up and/or swiped right and left.

By a third unique input, by gazing at a window, the first working area can be defined, wherein the window can be selected. By gazing, defining the working area, and selecting a point in the working area, the window can be moved from the first working area to the point in the working area.

Moving icons or windows or editing in a word processor or in a drawing editor will be much more effective and faster and will also reduce movements needed and thus physical strain and the risk of a tennis elbow, carpal tunnel syndrome, mouse shoulder, etc.

In an embodiment, the first position can be determined by also calculating a second distance between the gaze tracker and eyes of the user.

By calculating the second distance, the first position can be defined more closely to what the user is looking at. The working area can be optimized in size, for example, the working area can be made smaller while still comprising what the user is looking at, speeding up interactions.

That the working area is smaller can mean that the cursor positioned within the working area only needs to be moved a short distance, which saves time, increases precision and reduces movements needed and thus physical strain and the risk of a tennis elbow, carpal tunnel syndrome, mouse shoulder, etc.

Keeping track of the distance and adjusting the working area size accordingly also ensures that the working area does not get too small, should the user increase distance to the tracker and subsequently the display.

That the working area is smaller can mean that the working area just surrounds the item viewed by the user in the real world so that the corresponding item in the virtual world can be automatically selected, and the corresponding activity connected with the item can be activated in one step—one click on a button or one move by e.g. a hand.

That the first position and working area are defined more exactly means that there will be fewer wrongly defined first positions and working areas, where the user has to resend the gaze activation input, which will save time in conjunction with the reduced cursor (working area) distances that needs traversing.

In an embodiment, the method can further comprise the step of identifying a virtual item within the working area, wherein the virtual item is connected to a real item, wherein an activity is connected to the real item, and wherein the first user input can control the activity.

That the first user input can control the activity can mean that the first user input can activate or deactivate the activity. If the real item is a lamp, the first user input can switch on or off the lamp.

If the real item is a television, the first user input can control e.g. the channel to be shown on the television, the volume, the contrast, etc.

The smartphone can have one or two second cameras capturing an image or a sequence or stream of images of the surrounding of the user. The image or the stream of images can be processed and made available in a virtual environment context and presented on the screen of the smartphone.

The real item can e.g. be a real lamp that can be switched on and off. The real item can be other electric items as well, but for the sake of simplicity the lamp is hereby presented as an example. The lamp has a socket for the light bulb or a switch on the cord, where the socket or the switch has a receiver and the socket or the switch will switch on or off when the receiver receives a switch on signal or a switch off signal. The receiver preferably receives the signals wirelessly.

The real lamp has been paired with a corresponding virtual lamp. The virtual lamp can have stored images of the real lamp from different angles so that when the second camera(s) captures an image of the real lamp, the real lamp is recognised and connected with the virtual lamp. The virtual lamp can have stored data about features of the real lamp. The real lamp can have a lamp screen and/or a lamp base, and the features of the real lamp can be a profile, one or more colours, patterns, height-to-width relation, shape or combinations of these features of the lamp screen and/or of the lamp base and/or of other features of the lamp screen and/or of the lamp base as known from the literature. The data containing features will take up much less memory than storing an image of an item, like e.g. a lamp, a television.

If there are more than one lamp of the same type and appearance, the stored data can encompass the surrounding of each identical lamp so that the particular lamp can be determined based on the surrounding, like wall paper, other furniture, and/or positions or coordinates of each lamp of the same type can be registered in a database connected to the computer and the smartphone can have a GPS for determining the position of the smartphone/second camera(s) and e.g. a compass or gyrocompass for determining direction of the second camera(s), so that each lamp can be set apart even from other same looking lamps. Alternatively or in addition, the smartphone can have motion sensors (accelerometers) for continuously calculating via dead reckoning the position and orientation of the smartphone.

Alternatively, the real lamp can have an emitter (e.g. an RFID that when activated responds by transmitting an identification) or a passive identifier, (e.g. markings, e.g. spots of infrared paint painted in a certain pattern or a QR code etc.). The pattern or the QR code is unique for each item/lamp in the house or flat, so that the computer can easily distinguish one lamp from another. The virtual lamp can have stored a unique signal so that when the emitter emits the unique signal (preferably in the IR range so that the unique signal cannot be seen) so that the when the smartphone receives the unique signal the real lamp is recognised and connected to the virtual lamp. The emitter will preferably emit the unique signal when the receiver receives an emitting signal from the smartphone.

If the second camera(s) capture(s) images of the real lamp and presents the lamp as the virtual lamp on the screen of the smartphone, and if user looks at the virtual lamp as presented on the screen of the smartphone, the gaze tracker, if the gaze activating input is received, will determine the gaze direction of the user and define a working area around the virtual lamp on the screen. The real lamp and the virtual lamp are connected and the user can turn on and off the real lamp by sending the first user input e.g. by pressing a certain button or entering an activating input on the smartphone.

If the second camera(s) capture(s) images of the real lamp and presents the lamp as the virtual lamp on the screen of the smartphone, and if the user looks at the real lamp the gaze tracker, if the gaze tracker is activated, will determine the gaze direction of the user and determine that the user is looking at the real lamp, since the angle between the smartphone and the real lamp can be determined based on the gaze tracker and the second distance can be known (can normally be estimated to e.g. 0.5 m or if there are two first cameras, the first two first cameras can calculate the second distance) so that a gaze direction of the user's gaze can be well defined. Since the direction of the first camera(s) and the second camera(s) are well-defined (the directions of the first and second cameras are normally not changeable, but if the directions of the first and second cameras are changeable, the mutual directions can be determined) the gaze direction can be determined in the image on the screen of the smartphone. If the real lamp is positioned in that gaze direction, and the real lamp can be recognised and connected to the virtual lamp, the first position can be defined to be the virtual lamp in the virtual environment and the working area is defined around the virtual lamp on the screen.

Glasses or goggles may have a first camera looking at the eyes of the user for determining a gaze direction of the user. Since the glasses or goggles can be transparent, the user can also see the real world.

The glasses or goggles can comprise one, two or more second cameras directed away from the user for recording what the user is seeing and transmitting the information to a computer providing the virtual environment for analysing the information from the second camera(s). The glasses or goggles can have one transparent screen or two transparent screens for one or both eyes, where the computer can present to the user virtual information overlapping what the user sees of the real world. If the user looks at the real lamp through the glasses or goggles, the real lamp can be connected to the virtual lamp in the same away as presented above, and the user can turn on and off the real lamp. The glasses or goggles may comprise a positioning receiver like a GPS receiver for connecting to a satellite positioning system or a cellular network for determining the position and/or direction of the glasses or goggles. The glasses or goggles may comprise e.g. a compass, a magnetometer, a gyrocompass or accelerometers for determining the direction of the glasses or goggles. The glasses or goggles may comprise camera(s) and SLAM technique(s) to determine the position and direction of the glasses or goggles.

If a first item and a second item are within the working area, first distances between the user and each of the items can be determined and if the second item is much further away or even just further away than the first item, the first item may be decided by a software in the computer providing the virtual environment to be the relevant item, which the user wants to operate. The software may assist the user in aiming and find relevant items. If there are more than one item within the working area, the item will be marked in the virtual environment (e.g. by a ring around the item as seen by the user or have a cursor placed over the item) based on the item the software has decided or the user has told the software to be the most relevant item. In another context, the target closest to the centre of the working area may simply be deemed the relevant item. If e.g. the user is sitting in a sofa in front of a television and looking at the television, and there is a lamp in the gaze direction as well (the working area will be a frustum around the gaze direction) the software will deem the television the relevant item. If the user actually wants to turn on/off the lamp, the user can mark the lamp by clicking on the lamp on the screen of the smartphone or sending the instruction in another way e.g. using a wearable or a wearable input device that registers the movements of the fingers relative to each other and/or to the palm, wherein one certain movement means to shift item to be marked, and another certain movement means turn on/off the lamp. A certain gesture in front of a camera of the smartphone, where the software will understand that the certain gesture means to shift item to be marked, etc.

The item may not be visually represented in the virtual environment, but only seen in the real world by the user through the glasses or goggles, while the ring or other marking of the item is only seen in the virtual environment. The type of representations of real items within a virtual environment vary widely, the representations may be simplified or abstract representations of an item, for example a lamp may just be a switch, or complex approximations or proxies, for example a fully rendered avatar for an automated or robotics appliance that allows for interaction. Conversely, interactive real-world items may be as simple as surfaces/areas or directions.

If there are two items in the working area and the user considers that the wrong item is marked or is under a cursor, a third user input, preferably from the at least one input device different from the gaze tracker, can change the selection from the first item to the second item, and vice versa. The third user input can be pressing a button, or the user making a certain movement in front of a camera, e.g. the one or two second cameras, connected to the computer.

The item can be a lamp having a light bulb socket or a switch on a cord providing electrical power to the lamp, where the light bulb socket or the switch is controlled by the computer, so that the step of operating the virtual environment can be to switch on or off the lamp. Instead of a lamp, any other electrical item can be controlled, like a thermostat of a radiator, a television, a projector or image projector for providing still pictures or moving images controlled by a computer or a television broadcasting signal, a music centre, an air conditioning system, etc.

When an item is activated, a table can appear in the virtual environment, where the user can operate the item in more detail, e.g. adjusting temperature of the thermostat, the volume of a loudspeaker, channel of a television, etc.

In an embodiment, the real item is a certain distance from the user, and the virtual item is positioned with a focal length from the user corresponding or substantially equal to the certain distance.

The real item can be e.g. a television, where the user wants to change e.g. the loudness or volume.

The user may be wearing glasses or goggles described above having the first camera for looking at the eyes of the user and for determining a gaze direction of the user, having second camera(s) directed away from the user for recording what the user is seeing and transmitting the information to a computer providing the virtual environment for analysing the information from the second camera(s), and having at least one transparent screen for at least one eye, where the computer can present to the user virtual information overlapping what the user sees of the real world. The glasses or goggles may also comprise the means mentioned above for determining position and/or direction.

The virtual item or icon of e.g. the television can then be viewed by the user next to the real item. For avoiding that the user has to change focus when going from the real item to the virtual item and back again, when changing e.g. volume, contrast, etc. of the television, the virtual item is presented to the user at a distance and/or with a focal length from the user corresponding or equal to the distance from the user of the real item.

In an embodiment, the step of operating the virtual environment within the working area only can be terminated by a deactivation input received from the user.

The gaze tracker can comprise one or two first cameras for continuously (after the gaze activation input has been received and until the deactivation input is received) capturing images of one or both eyes of a user. The gaze tracker only needs to use computational power when the user has activated the gaze tracker.

After the gaze activation input from the user has activated the gaze tracker so that the first position and the working area have been defined, the step of operating the virtual environment within the working area only can continue until the deactivation input is received from the user. The advantage is that an item that has been marked and activated like a lamp that has been turned on can be turned off again without having to activate the gaze tracker and define the working area around the lamp again. Just a lamp deactivating input on the smartphone will turn off the lamp when e.g. the user leaves the room. The integrated gaze interaction with a virtual environment can be presented in an application. The application can be available on one page in the smartphone, so that other activities can be performed like talking by phone, listening to radio etc. on other windows, while the working area is still defined until the deactivation signal is received in the application regarding the integrated gaze interaction with the virtual environment.

Keeping the working area defined can also be advantageous when the real item is a television instead of a lamp. It is not necessary to activate the gaze tracker and define the working area for changing the volume or for selecting another channel as long as the working area is defined around the television and the virtual television connected to the real television is identified.

The deactivation input can be a certain movement in front of a first camera or pressing a certain button or depressing the button used as the gaze activation input.

In one embodiment, the gaze activation input can be touching or positioning a body member, such as a finger, on a trackpad. Touching or positioning a body member, such as a finger, on a trackpad, can be the gaze activation input for activating the gaze tracker. Such a gaze activation input is very time efficient for controlling e.g. a cursor on a display. The user just looks at the position in the virtual environment, where the user wants the working area to be and touches the trackpad or positions the body member on the trackpad. Since the body member is now resting on the tracking pad or close to the tracking pad, the user can easily operate the virtual environment within the working area through the tracking pad, e.g. by controlling the cursor. The procedure is straightforward and natural for the user.

After adding e.g. a text passage using e.g. a computer keyboard to the virtual environment within one window application, the user may want to add a further text passage to the virtual environment within another window application, which can be done by just touching the trackpad by the body member, e.g. a finger, or positioning the body member on the trackpad for activating the gaze tracker, defining the first position and the working area for operating the virtual environment within the working area, e.g. by adding the further text passage. No further action compared to the normal procedure of moving the cursor to the other window application and activating the other window application using the trackpad for adding the further text passage is necessary. Instead, the procedure is just faster since the gaze tracker will immediately determine, where the user is looking, and e.g. activate that window application for adding the further text passage.

When playing computer games, the user may have to send different instructions to the virtual environment at many different positions on the display. To activate a window application or icon and then a next window application or icon, etc. in the display fast will increase the amount of the information that the user can provide information to the virtual environment. By just touching or positioning the body member on the trackpad, the gaze tracker is activated for defining another first position and working area, and the user can provide the information to the virtual environment fast.

The trackpad may have a capacitance sensor that is able to sense a body member, like a finger, approaching the trackpad already before the body member has touched the trackpad. If the time period between the receipt of the gaze activation input until the gaze tracker is activated is long from the user point of view, so that the user has to wait for the gaze tracker to be activated, which could at least be the case if the gaze tracker is switched off when the gaze tracker is not activated, then the gaze tracker can be switched to a semi active state when the body member is sensed to approach the trackpad. The semi activated gaze tracker is not performing any gaze tracking measurement of the eyes of the user or at least is not forwarding gaze tracking measurement of the eyes of the user to the computer or processor for defining the first position, but the time period between the receipt of the gaze activation input until the gaze tracker is activated will be shorter because the time period from the semi activated state to the activated state of the gaze tracker is shorter.

The tracking device, like the trackpad, can be a capacitance-based trackpad, which can sense a finger approaching the trackpad even before the finger touches the trackpad. When the trackpad senses a finger approaching the trackpad a proto-gaze activation input can be received by e.g. a computer or a processor connected to the trackpad so that the gaze tracker is half activated (going e.g. from dormant to half-activated) for preparing the gaze tracker for being activated so that the activation of the gaze tracker when the gaze activation step is finally received will be shorter and the process can be more optimised.

In one embodiment, the gaze activation input can be moving a body member, such as a finger, a hand or an arm, a toe, a foot, or a leg into a field-of-view of the camera or into a certain first volume or first area of the field of view.

Using a camera for receiving the gaze activation input, can mean that certain movements or positions of the user in front of the camera will be recorded or registered by the camera and processed by a processor for connecting a certain movement or position with a certain instruction. One instruction can be a gaze activation input for activating the gaze tracker, where the gaze activation input is moving the body member into the field-of-view of the camera or into the certain first volume or first area of the field of view.

The user just looks at the position in the virtual environment, where the user wants the working area to be and moves the body member into the field-of-view of the camera or into the certain first volume or first area of the field of view, constituting a gaze activation input. Since the body member is now within the field-of-view of the camera or within the certain first volume or first area of the field of view, the user can easily operate the virtual environment within the working area by providing other moves and/or positions of the body member that correspond to certain commands to operate the virtual environment within the working area.

If the virtual environment as presented to the user is superimposed on top of the real world, like if the user is wearing e.g. the goggles or the glasses for detecting the gaze, then looking at a position in the real world will mean that the user is also looking at the corresponding position in the virtual environment. By looking at e.g. a lamp in the real world when the body member is moved into the field-of-view of the camera or into the certain first volume or first area of the field of view, the gaze activation input is received and the working area will be defined and surround the lamp or a switch of the lamp in the virtual environment so that by providing a move or position of the body member corresponding to switching on or off the lamp, the user can operate the switch in the virtual environment so that if the switch in the virtual environment is controlling the switch in the real world, then the user can easily switch on or off the real lamp.

By using the camera, the user can operate the virtual environment.

If the gaze tracker is activated when the body member is moved into the first volume or the first area of the field of view, then the gaze tracker may be switched to the semi active state when the body member is within the field of view of the camera or within a second volume or a second area (that is larger than first volume or the first area, but smaller than the field of view), so that the duration from the receipt of the gaze activation input from the user until the gaze tracker is tracking or activated can be shortened or eliminated, and the user can operate the virtual environment even faster.

In one embodiment, a first relative movement or position of the different relative movements or positions between two body members such as fingers of a hand and/or between a finger and a palm of the hand registered by the wearable can be the gaze activation input.

Using the wearable for receiving the gaze activation input, can mean that certain relative movements or positions of the user will be registered by the wearable and processed by a processor for connecting a certain movement or position with a certain instruction. The first relative movement or position can be the gaze activation input for activating the gaze tracker.

The user just looks at the position in the virtual environment, where the user wants the working area to be and performs the first relative movement or position by the hand, arm, foot, leg, or neck or whatever body member wearing the wearable.

As described above regarding positions and/or movements in front of the camera, the user wearing the wearable can by also wearing e.g. the goggles or the glasses for detecting the gaze, control lamps, televisions, etc.

By using the wearable the user can operate the virtual environment.

The wearable can sense the position of the body member so that the wearable can sense that the body member is within a certain distance of the position that corresponds to the gaze activation input. When the body member is within the certain distance of the position that corresponds to the gaze activation input, a proto-gaze activation input can be received by e.g. a computer connected to the wearable so that the gaze tracker is half activated (going e.g. from dormant to half-activated, etc.) for preparing the gaze tracker for being activated so that the activation of the gaze tracker when the gaze activation step is finally received will be shorter and the process can be more optimised.

In one embodiment, the first relative movement or position of the different relative movements or positions can be moving or positioning one finger of the hand wearing the wearable within a second volume or second area, preferably adjacent the palm of the hand wearing the wearable.

Moving or positioning one finger, preferably the thumb, of the hand wearing the wearable within a second volume or second area would be a suitable first relative movement or position that is natural to perform, especially if the second volume or second area is close to the palm of the hand wearing the wearable.

In one embodiment, the gaze activation input can be the first finger touching the second finger or the palm at a certain first position. By the gaze activation input being the first finger touching the second finger or the palm, the user will know that the gaze activation input has been sent. There will few false gaze activation inputs. The user will not send a gaze activation input by accident. The first position can be at a distal phalange, an intermediate phalange, or a proximal phalange of the second finger, or at a metacarpal or a carpal position of the palm. Each area could be a different type of input. The distal phalange can e.g. be for moving the cursor and standard tapping, the intermediate phalange for scrolling and “right clicks” and the proximal phalange for swipes and dragging interactions.

In one embodiment, the gaze activation input can be moving one finger or the first finger of the hand wearing the wearable within the second volume or second area or touching the certain first position twice within a first time period. With this gaze activation input, the risk is reduced that the user will accidentally activate the gaze tracker.

In one embodiment, the gaze activation input can be a second signal from the electromyography or the neural and/or muscle activity tracker, wherein the second signal is a nerve signal or a muscle signal for moving a certain body member, wherein the nerve signal or muscle signal is picked up by the electromyography or the neural and/or muscle activity tracker. A user who has lost e.g. a hand can still send a gaze activation input and operate the virtual environment.

In one embodiment, the first time period can be less than 2 s, preferably less than 1 s, more preferably less than 0.5 s, or between 0.1 s and 1 s, preferably between 0.2 s and 1 s, even more preferably between 0.1 s and 0.5 s. These are reasonable time periods.

In an embodiment, the first position can be defined at an instant when the gaze activation input is received, or at an instant when the gaze activation input is received the first position can be defined, or, if the user accidentally closes the eyes or the eyes are saccading, at the instant the eyes are open and gazing again. The first position and the working area will be defined instantly, so that no time is wasted and the user does not need to wait for the software nor is the user forced to maintain gaze and focus on an area for extended periods of time, which will relieve the eyes and the muscles around the eyes, so that the user will be less exhausted and minimizes the mental effort that effort must be exerted to force the eyes to perform actions different from normal scene/environment scanning.

In an embodiment, the gaze activation input can be selected from the group of:
activating a first button of the at least one input device,
touching the at least one input device,
performing an activating movement by a body member, like an arm, a hand, a leg, a foot, or a head, wearing a wearable or a wearable input device, and
performing an activating movement or activating position in front of a first camera.

The first button can be understood to mean anything that can be interchanged between at least two states, preferably an activated state and a deactivated state. The first button can be a physical button or a virtual button e.g. on a screen that can be interchanged between at least two states, preferably an activated state and a deactivated state.

The activating movement can be a movement of a movement sensor, worn e.g. as a bracelet around the wrist, where the movement sensor can have a directional sensitivity so that movement sensor can distinguish movements in different directions or the movement sensor can have no directional sensitivity so that the movement sensor can only distinguish between movement and no movement. The movement sensor having directional sensitivity can have many different instructions connected with each unique movement or combination of movements, where one unique movement is connected with the gaze activation input. Moving to a position in correspondence to a certain activating position in the virtual environment or moving into a certain activating pose may also constitute an activating movement input.

A software program can be configured for receiving information from the camera and for connecting movements by the user recorded by the camera to instructions, like the gaze activation input.

In an embodiment, the step of defining the first position and/or defining the working area can be performed if a duration of touching the at least one input device is longer than 70 or 75 ms.

In this way false, at least some gaze activation inputs or at least some received gaze activation inputs from the user, where the user did not intend to define a working area, can be discarded.

In an embodiment, a previous working area can have already been defined, and wherein the previous working area can be kept if a duration of touching the at least one input device is less than 75 ms or between 35 ms and 75 ms or less than 100 ms or between 35 ms and 100 ms, or even less than 250 ms or between 35 ms and 250 ms. The advantage is that the user can still tap the at least one input device without defining a new first position and/or a new working area.

If the touching is less than 35 ms, the touching can be regarded as a fault instruction and be discarded so that no first position and/or no working area is defined. The upper limit of 75 ms or 100 ms or even 250 ms can be personally set, since somebody may prefer 100 ms or even 250 ms because that somebody may have difficulty tapping faster than 100 ms or than 250 ms, while another person might prefer the 75 ms limit because the operations can be performed faster. This ensures that the system can accommodate the preferences and requirements of a wider range of people, regardless of dexterity.

The gaze activation input can be the initial step of the gaze interaction and signals the acquisition of a gaze position at time t. The defined working area can be realized at time t+x where x is a threshold value of e.g. 70 or 75 ms. If the gaze activation input is e.g. resting a finger on a trackpad longer than the threshold value, and if the finger is lifted from the trackpad before the end of the threshold value, then the finger will be resting on the trackpad for too short a time to be a valid gaze activation input. No working area will be defined. If the gaze activation input is e.g. resting a finger on a trackpad at the same spot longer than the threshold value, and if the finger is lifted from or moved on the trackpad before the end of the threshold value, then the finger will be resting on the trackpad at the same spot for too short a time to be a valid gaze activation input. No working area will be defined. In both examples, the user may execute another interaction that does not involve defining a working area. A certain movement of a first body member like a finger may also be used to cancel the threshold and prompt a new working area immediately upon movement. Another certain movement of the first body member may also be used to cancel the threshold and to reuse the last defined working area.

In an embodiment, the deactivation input can be selected from the group of:
deactivating the or a first button,
activating the first button a second time,
activating a second button,
un-touching the at least one input device,
touching the at least one input device a second time,
performing a deactivating movement or deactivating position by a body member, like an arm, a hand, a leg, a foot, or a head, wearing the wearable input device, and
performing a deactivating movement or deactivating position in front of a first camera or the first camera.

Deactivating the first button can mean that after the first button has been activated, the first button is pressed again for deactivating the first button and for terminating operating the virtual environment within the working area.

The user can also operate the virtual environment within the working area as long as the user is pressing or resting a body member, such as a finger, on the first button, and when the user removes the body member from the first button, the operation of the virtual environment within the working area is terminated.

The user can also operate the virtual environment within the working area as long as the user is touching or resting a body member, such as a finger, on the at least one input device, and when the user un-touches the at least one input device, the operation of the virtual environment within the working area is terminated.

Activating the first button a second time can mean that after the first button has been activated, the first button is pressed again for activating the first button again for terminating operating the virtual environment within the working area.

Touching the at least one input device a second time can mean that after the at least one input device has been touched a first time, the at least one input device is touched again for terminating operating the virtual environment within the working area.

Activating the second button can be deactivating the first button or activating the first button a second time. The second button can be another button than the first button.

The deactivating movement can be a movement of a movement sensor, worn e.g. as a bracelet around the wrist, where the movement sensor can have a directional sensitivity so that movement sensor can distinguish movements in different directions or the movement sensor can have no directional sensitivity so that the movement sensor can only distinguish between movement and no movement. The movement sensor having no directional sensitivity can both be used for the gaze activation input and for the deactivation input, where every second movement of the movement sensor having no directional sensitivity is for the gaze activation input and every other movement of the movement sensor having no directional sensitivity is for the deactivation input. Alternatively, a double movement of the movement sensor having no directional sensitivity can be or be connected with the gaze activation input and a single movement can be or be connected with the deactivation input, or vice versa.

The movement sensor having directional sensitivity can have many different instructions connected with each unique movement or combination of movements, or each position or combination of positions where one unique deactivating movement or position is or is connected with the deactivation input.

A software program can be configured for receiving information from the camera and for connecting one or more movements by the user recorded by the camera to the deactivation input.

The first camera can be the camera.

In an embodiment, the at least one input device can be selected from the group of: mouse, trackpad, touchscreen, trackball, thumb stick, trackpoint, hand tracker, head tracker, body tracker, body member tracker, console controller, wand controller, cross reality (XR) controller, and virtual reality (VR) controller.

The first or the second button can be a button on the mouse, the trackpad or the trackball or one of the buttons adjacent the trackpad or the trackball.

In an embodiment, the virtual environment can be displayed on a display selected from the group of:
an electronic visual display,
a see-through electronic visual display,
a user interface of an electronic processing device,
a user interface of a specific application of an electronic processing device, and
3D visual display such as a holographic display or stereographic display.

The electronic visual display can be an electronic screen, an XR head-mounted display or glasses, augmented reality glasses, augmented reality goggles, augmented reality contact lenses, or a head-mountable see-through display. The see-through electronic visual display can be a transparent electronic screen.

The stereographic display can be two images projected superimposed onto the same screen through polarizing filters or presented on a display with polarized filters, and the viewer wears eyeglasses which also contain a pair of opposite polarizing filters.

In an embodiment, the electronic visual display can be augmented reality glasses, augmented reality goggles, augmented reality contact lenses, or a head-mountable see-through display.

In an embodiment, the working area can be visualized to the user in the virtual environment when the working area is defined.

The working area can be visualized by a visible frame surrounding the working area. That will immediately show the user whether the item, object or area the user is/was looking at is within the working area. If not, the user can immediately send a new gaze activation input. The user will be able to correct a wrongly placed working area immediately. The visible frame can also inform of the movement requirements for possible activity within the working area, which invokes more precise control, using the first user input. The visible frame can help in teaching the user how the gaze tracker interprets the position of the eyes.

In an embodiment, operating the virtual environment can comprise at least one of the steps of:
selecting an application or element within the working area,
activating an application or element within the working area,
deactivating an application or element within the working area, and
controlling an application or element within the working area.

The cursor can be moved on a screen within the working area to the application or element for selecting the application or element. By having the cursor positioned so that the application or element is ready to be selected, the user can send an activation signal for activating an application or element.

If an item is within the working area, the item can automatically be selected and the step of operating the virtual environment comprises activating the application or element connected with the item within the working area. The activation or deactivation of the application or element connected with e.g. an item in the form of a lamp, can be used to turn on and off the item or lamp.

If an item like e.g. a television is selected in the working area, e.g. a volume of a loudspeaker of the television, a channel shown on the television, or a contrast of the colours shown on the television can be controlled within the working area.

Selecting the application or the element within the working area can be achieved by moving a cursor or selection indicator over an icon representing the application or over the element. The cursor can e.g. be moved to be positioned over a scrollable or swipable window or area so that the user can scroll or swipe the window or area, e.g. by moving two fingers on the trackpad.

Examples could be moving the cursor within the working area or from a first working area to a second working area, performing a gesture on an element like an application window or application slide, e.g. two finger scroll, pinch or three finger swipe on a track pad to respectively scroll the element, zoom in or out on the element or send a message to the element to go back to the previous element state, tapping, and/or clicking, and/or touching, and/or selecting a radio button element in a menu that alters the state of other elements that may or may not be within the working area, like toggling the display of file extensions in a file browsing system, and/or performing a cursor over one element in a selection to produce a tooltip that displays aggregate information about the entire selection, of which selected elements may or may not be within the working area.

In an embodiment, a size or a diameter of the working area can be adjustable by the user.

With experience, the user gazing at a certain spot will find out how exact the gaze tracker is in defining the first position and the user will preferably adjust the size of the working area so that the defined working area always or at least nearly always comprises the certain spot, and/or covers the desired part of the virtual environment being gazed at. A larger working area than what is necessary just means that the cursor will have to be moved a longer distance and/or more than one item is more likely to be covered by the working area so that the user has to select the item the user wants to activate or deactivate e.g. via the first user input. A larger working area is a useful attribute in several workflows where the user might be manipulating a group of elements, a bigger working area allows the user to do so without having to repositioning the working area.

The user can also adjust the size or the diameter of the working area during the step of operating the virtual environment within the working area only.

In one embodiment, the working area can be moved by the user during the step of operating the virtual environment within the working area only.

In an embodiment, a size or a diameter of the working area can be adjustable e.g. by the virtual environment itself. Using software-based profiling—like e.g. AI, which can be taught to adjust the working area to user preferences, the virtual environment or a subsystem working with the virtual environment is able to adjust the size of the working area to always or at least nearly always comprise the certain spot and/or desired virtual environment content, at which the user is gazing and also accommodate preferred user workflow into working area size, optimizing single target coverage or cluster coverage.

The disclosure also relates to a data processing system comprising
a gaze tracker,
an input device,
a processor configured to perform the steps of the method according to the present disclosure, and
optionally an electronic visual display providing visualization of a virtual environment.

The electronic visual display can be an electronic screen, an XR head-mounted display or glasses, augmented reality glasses, augmented reality goggles, augmented reality contact lenses, or a head-mountable see-through display.

The disclosure also relates to a computer program comprising instructions which, when the program is executed by a computer, cause the computer to carry out the steps of the method according to the present disclosure.

The computer may comprise a processor. The computer can be wirelessly connected or wired to the gaze tracker.

In an embodiment, the computer can be further connected to a tracking device, like a trackpad, a camera for allowing the user to operate the virtual environment, and/or a wearable, such as a dataglove.

The computer can be wirelessly connected or wired to the tracking device, the camera, and/or the wearable.

The wearable can also be for e.g. a foot or for a neck, or for an elbow, or for a knee.

### DESCRIPTION OF THE DRAWINGS

The disclosure will in the following be described in greater detail with reference to the accompanying drawings:

FIG. 1 a schematic view of computer screen with a gaze tracker

FIG. 2 a schematic view of a hand with a wearable input device

FIG. 3 a schematic view of glasses with a gaze tracker

FIG. 4 a schematic view of television screen with a gaze tracker positioned in a smartphone

FIG. 5 a schematic view of how the movement of a person influences the direction of the gaze

FIG. 6 a schematic view of a virtual mixing console and a real mixing console

### DETAILED DESCRIPTION

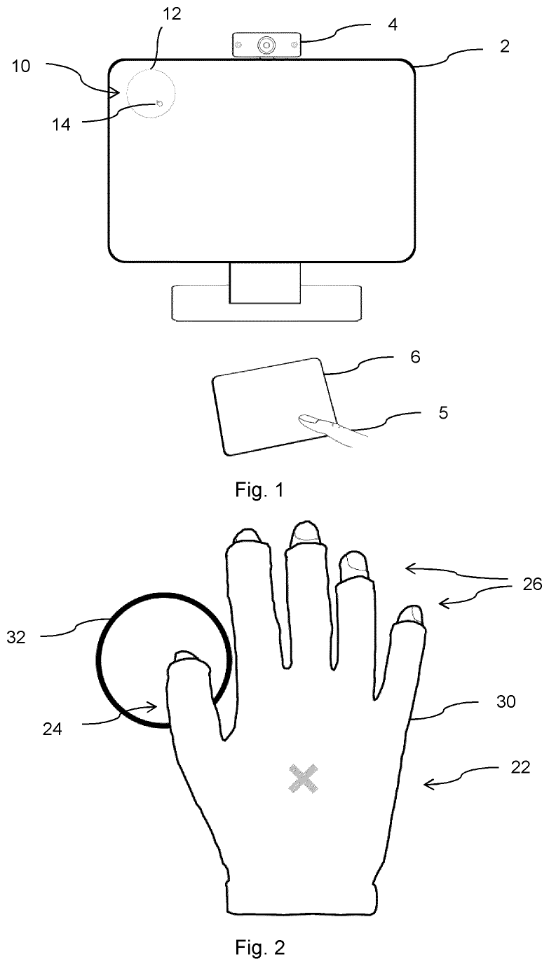

FIG. 1 shows a computer screen 2 connected to a computer (not shown) with a gaze tracker 4 turned towards the user (not shown) of the computer, and an electronic pad 6, like a trackpad, which could have been a computer mouse or anything else, from which the user can send a gaze activation input to the computer for activating the gaze tracker. The gaze activation input can be a finger 5 clicking on the electronic pad 6 or the finger resting on the electronic pad 6. It is preferable that the gaze activation input is a unique input, like a triple click, a double click with at least two fingers, or a click on a button or a gesture that is not used for anything else, so that the gaze tracker is not mistakenly activated.

When the gaze activation input has been received, the gaze tracker 4 provide data for where the eyes of the user are directed. In the presented example, the gaze tracker determines that the user is looking at the upper left corner of the screen. A first position (not shown) is defined within the virtual environment based on the input from the gaze tracker 4. Around the first position a working area 10 is defined with, in the shown example, a visible border 12. The border 12 can also be invisible. In this example a cursor 14 is moved to within the working area, so that the user only needs to move the cursor a little but further within the working area 10 to be able to activate whatever the user wants to activate on the screen. The advantage is that the user does not need to move the cursor from one end of the screen to the other by the finger 5 and arm (not shown), nor will the cursor need to be found before use as the cursor is moved to the first position of gaze, where the user desires to interact. The cursor can be moved faster and more precisely around on the screen and a physical strain can be avoided.

If a gaze deactivation input has been received, a new gaze activation input can activate the gaze tracker to define a new first position and a new working area. The gaze deactivation input can be achieved by deactivating the button that was activated for activating the gaze tracker, by releasing the activation button, or by pressing the activation button again for deactivating the gaze tracker or another deactivation button is pressed.

FIG. 2 shows an alternative way of instructing the computer. A hand 22 with a thumb 24 and fingers 26 and a palm (not shown), wherein the hand is wearing a wearable input device 30 like a dataglove. The thumb can move into a volume 32. By moving the thumb and/or one, two or more fingers in relation to a landmark of the wearable input device 30, for example where the palm of the hand is the landmark, the wearable input device 30 can register the movement into and within the volume 32 and transmit a signal. The thumb or a finger can also be a landmark. There are many known ways to register the movement of the thumb and the fingers in this way. Senseglove (Delft, The Netherlands) and Noitom International Inc. (Miami, Florida, USA) are just two providers of datagloves. The signal from the wearable input device 30 can be transmitted, preferably wirelessly, to the computer e.g. as a gaze activation input, for moving the cursor within the working area, as a deactivation input, item activating input, etc. Each one of the fingers 26 can also have a wearable input device. The combination of the movement of the thumb and one of the fingers, while the other fingers are not moving, can indicate one signal. The combination of the movement of the thumb and another of the fingers, while the other fingers are not moving, can indicate another signal. The combination of the movement of two fingers, while the thumb and the other fingers are not moving, can indicate a third signal, etc. With the thumb and all the fingers wearing the wearable input devices, many different instructions can be sent to the computer for controlling the gaze tracker, the cursor, etc.

Instead of the thumb and the fingers wearing the wearable input devices, hands, legs, feet, and/or head can wear wearable input devices.

Instead of wearing the wearable input devices one or more third camera(s) can capture the movements of the thumb, fingers, hands, legs, feet, and/or head for receiving instructions from the user for controlling the gaze tracker, the cursor, etc.

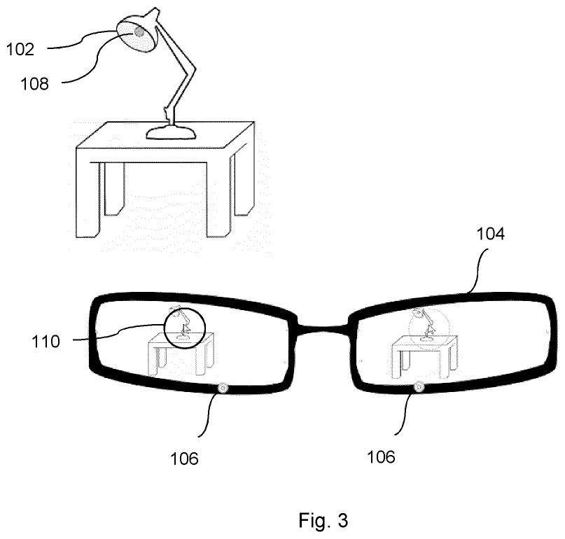

FIG. 3 shows a lamp 102. The lamp is seen through a pair of augmented reality glasses 104 worn by a user (not shown), where the glasses have a gaze tracker 106 in the form of two first cameras 106 on the inside of the glasses facing the eyes of the user. In addition, the glasses have one or two second cameras (not shown) looking in the direction of the user away from the user. Instead of the glasses 104 covering both eyes, the glasses could be just covering one eye or a part of one eye, where only the direction of one eye is determined for determining the gaze direction. Instead of two first cameras 106, one single first camera 106 would also be suitable in most cases. The first, second and third cameras can be, preferably wirelessly, connected to a computer of a computer system for transferring the information about the gaze direction of the eyes of the user and about what the user sees through the glasses. The second camera(s) and the third camera(s) can be the same.

The lamp 102 with a light bulb 108 has a socket (not shown) for the light bulb or an electric switch (not shown) which is connected, preferably wirelessly, to the computer, so that the computer can switch on and off the light of the lamp.

In this embodiment, the user is not necessarily sitting in front of a computer screen. By sending the gaze activation input e.g. by using the wearable input device(s) presented in FIG. 2, preferably wirelessly, or by pressing a button on e.g. a smartphone, which is preferably wirelessly connected to the computer, the gaze tracker is activated. The computer can be part of the smartphone or another mobile computing device.

The gaze tracker determines that the user is gazing in the direction of where the lamp is, and a working area 110 is created in the virtual environment around the lamp in the real world as seen from the user through the glasses. The computer can have a comparison software for comparing the picture of the room as recorded by the second camera(s) with the gaze direction as determined by the gaze tracker, for determining that the user is looking at the lamp 102. In addition or as an alternative to the second camera(s), the computer can have the location in the room of the socket or the electric switch controlling the lamp and connected to the computer electronically stored. The computer system can comprise means for regularly updating the location of the socket or the electric switch so that the computer system will know a new location of the lamp if the lamp has been moved, as is known practice within the art of computer vision and particularly the field of Simultaneous Localization And Mapping (SLAM), the physical environment can be processed as images and, e.g. be semantically segmented, identifying/labelling a lamp capable of interaction and some features containing item localization information allowing for the updating of a virtual environment. See Taketomi et al., IPSJ Transactions on Computer Vision and Applications (2017) 9:16 or Fuentes-Pacheco et al., Artificial Intelligence Review 43 (2015) 1.

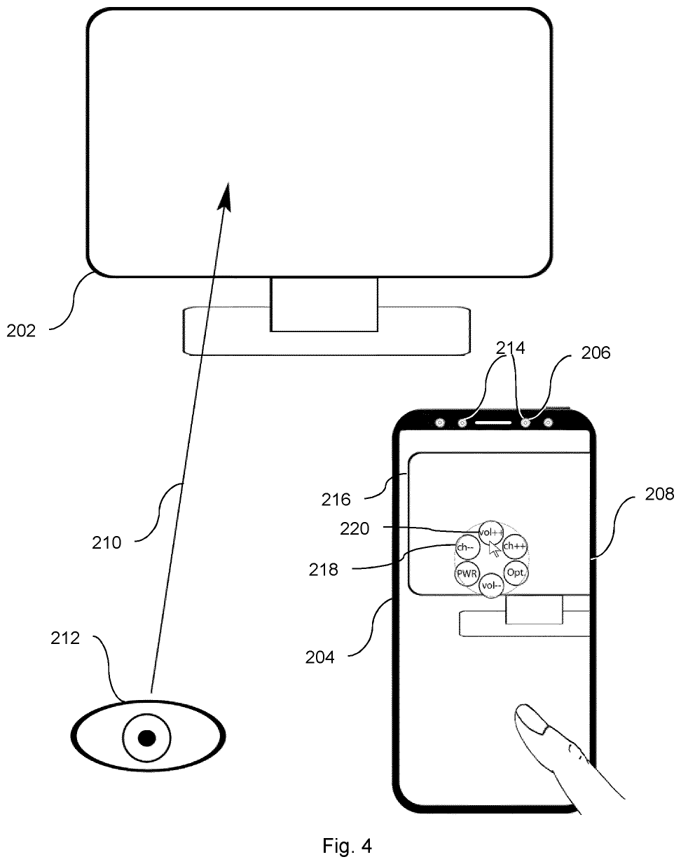

The working area is preferably marked by a circle 110 or other shape so that the user can see what the computer system considers that the user is looking at. If the working area is not what the user intended to look at/activate, the user can send a new gaze activation input for redoing the gaze tracking. If the working area is what the user intended to look at/activate, the user can send a first user input through e.g. the wearable input device(s) presented in FIG. 2, or by pressing a button on e.g. the smartphone for turning on or off the lamp. If there are two different lamps, which are controlled independently, and the two lamps (lamps are to be understood to as representing electrical items that are frequently turned on and off) are positioned in the gaze direction, the first one of the lamps is marked to be activated/deactivated by the first user input, by marking the second lamp, the second lamp will instead be activated/deactivated by the first user input. When the working area comprises two or more lamps, the cursor may appear within the shown or not shown working area, and the cursor can be moved by a finger on the screen to the lamp to be activated/deactivated so that that lamp can be marked and the FIG. 4 shows an alternative embodiment to the embodiment shown in FIG. 3. Instead of the lamp as in FIG. 3, a television 202 is controlled. FIG. 4 is also an alternative embodiment to the embodiment shown in FIG. 1, where a smartphone 204 has a gaze tracker 206 instead of the gaze tracker being positioned in the screen or next to or on top of the screen as in FIG. 1. The smartphone has a smartphone screen 208, which can be a touch sensitive screen. The gaze tracker 206 is used for determining a gaze direction 210 of an eye 212 of a user (not shown). The smartphone can be connected to a stationary computer for performing the calculations about where the user is gazing and at which item (lamp, television, radio, etc.) the user is gazing. Alternatively, the smartphone can be the computer and can have software and hardware for performing all the calculation without assistance of another computer. The smartphone also comprises a second camera (not shown) on the rear side of the smartphone for capturing a stream of images of the room as the user sees the room. Based on a comparison of the gaze direction 210 determined by the gaze tracker 206, on objects seen by the second camera, and on a second distance between the smartphone 204 and the eye 212 (normally around 0.5 m), two angles and one side in a triangles can be known so that the triangle is well-defined, and the object, on which the eye is looking, can be determined. The smartphone can have a distance meter (not shown) for measuring the second distance between the smartphone and the eye (or close to the eye to avoid a laser light shining into the eye) or between the smartphone and the object, at which the eye is looking. The distance meter can determine distance by measuring head size of the user using a camera of the smartphone, using structured light or by using two cameras.

Alternatively, the gaze tracker may comprise two cameras 214 next to each other looking in the same direction for determining the second distance between the smartphone and the eye, or the smartphone can have two second cameras (not shown) next to each other looking in the same direction for determining a third distance between the smartphone and the object, at which the eye is looking.

If the smartphone has a distance meter or the distance between the smartphone and the eyes is supposed to be the 0.5 m as mentioned above, and if the gaze direction of the eyes of the user is determined by the gaze tracker, and if the orientation and the position of the smartphone are determined, and if a real item having a corresponding virtual item in the virtual environment, where the real item is seen by the user in the gaze direction, then the software can calculate that the real item is seen by the user and the first position is defined on or close to the virtual item and the working area is defined with the virtual item within. The user can mark the virtual item and activate/deactivate/control the real item.

The software may calculate the direction in which the user is looking and present the view the user sees on the screen of the smartphone with virtual item(s) having a corresponding real item(s) along the gaze of the user presented on the screen so that by the first user input, e.g. by clicking on the virtual item on the screen the user can activate/deactivate/control the real item.

In this case, the gaze tracker has determined that the user is looking in the direction, where the television is located. The images captured by the second camera can be presented on the smartphone screen 208 for the user where a first image 216 of the television is shown.

The computer/smartphone can have the image stream processing software of the embodiment presented in FIG. 3 for being able to discern which item the user is looking at, and/or the computer/smartphone can have the location in the room of the television electronically stored, and vice versa. The computer system can comprise means for regularly updating the location of the television so that the computer system will know a new location of the television if the television has been moved as is known practice within the art of computer vision and particularly the field of Simultaneous Localization And Mapping.

The first image 216 of the television is defined in the virtual environment to be the first position and a working area is defined around the first image of the television. By e.g. pressing a button appearing on the smartphone screen 208 a first user input can be sent to the computer system by the user for turning on the television 202.

When the television 202 is turned on or enabled, the smartphone 204 can transmit inputs or engage an application, where the user can control the television.

If the user wants to choose a channel, the user will send a gaze activation input for activating the gaze tracker. The gaze tracker defines a first position in the smartphone screen 208 at a first icon(s) 218 about the channels. A working area is defined around the first icon(s) 218 and the correct channel can be chosen. If the user wants to change the volume of the television, the user will send a gaze activation input for activating the gaze tracker. The gaze tracker defines a first position in the smartphone screen 208 at a second icon 220 about volume. A working area is defined around the second icon 220 and the correct volume can be chosen.

Alternatively, the gaze tracker determines that the eyes are looking at the television 202 on the smartphone screen 208. The television can as easily be controlled by the user gazing at the smartphone screen 208 as on the television 202.

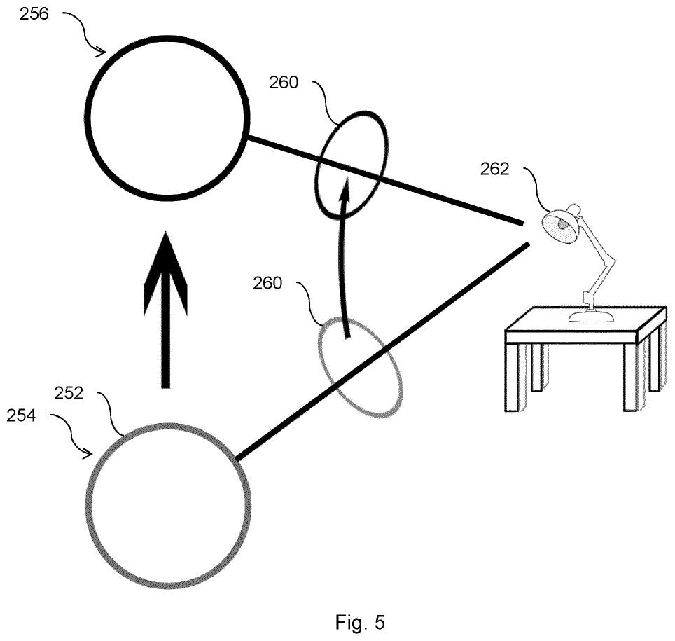

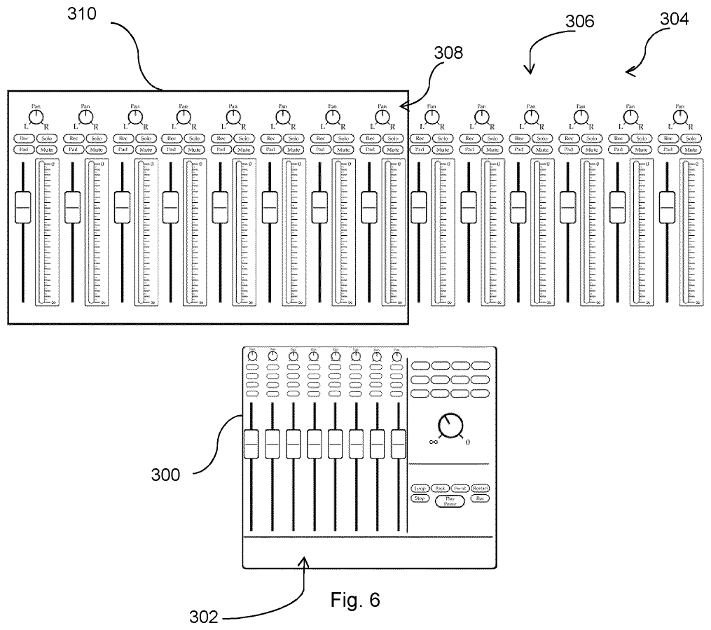

FIG. 5 shows a user 252 holding a smartphone (not shown) with a gaze tracker. The user has activated the gaze tracker, so that based on gaze tracker user input a first position and a working area 260 can be defined in a corresponding virtual environment that is maintained in accordance with a system providing SLAM/pass through. The user is moving from a first location 254 to a second location 256. During the movement of the user, the working area 260 is moved within the virtual environment so that an item in this case a lamp 262 with a representation in the virtual environment, here a lamp, that was covered by the working area when the user was at 254, still resides within the working area from the perspective of the user at 256, to the extent that this is indeed possible due to perspective shift and skew. In a similar fashion, if the item(s) detected within the working area moves, the working area may move as well or, in minor movement cases expand, to keep the items within the working area. A cursor may preferably likewise move with the working area.

FIG. 6 shows a real mixing console 300 comprising a first number of first channels 302, where the real mixing console 300 is connected to a computer (not shown) having a software presenting a virtual mixing console 304 comprising a second number of second channels 306. The virtual mixing console 304 may control up to the second number of input channels with signals from microphones, signals from electric or electronic instruments, or recorded sounds. The first number may be smaller or even much smaller than the second number.

A real mixing console with many channels is expensive and takes up a lot of space, and a virtual mixing console may be more complicated to control than the real mixing console.

With the virtual mixing console 304 shown on the screen, the user may activate the gaze tracker while looking at a first selection 308 of the second channels 306 the user wants to change. A working area 310 is defined around the selection of the second channels 306, where the working area may comprise as many second channels as there are first channels.

The software is configured for controlling the first channels 302 based on the second channels 306 within the working area, so that the first channels 302 have the same positions and settings as the second channels 306.

By moving the first channels 302, the user will control the first selection 308 of the second channels 306 of the virtual mixing console 304 within the working area. If the user wants to adjust some other second channels, the user just needs to activate the gaze tracker while looking at the other second channels. Another working area (not shown) is defined around the other second channels, and the software will control the first channels 302 based on the other second channels within the other working area, so that the first channels 302 have the same positions as the other second channels. By moving the first channels 302, the user will now be able to control the other second channels of the virtual mixing console 304 within the other working area.

A cost-effective mixing console with very many channels that is easy to control is provided.

1-41. (canceled)

42. A method for integrated gaze interaction with a virtual environment, the method comprising:
receiving a gaze activation input from a user to activate a gaze tracker;
defining a first position in the virtual environment based on a gaze tracker user input as determined by the gaze tracker;
defining a working area adjacent the first position as only a part of the virtual environment; and
operating the virtual environment within the working area only, by a first user input from at least one input device different from the gaze tracker.

43. The method according to claim 42, wherein defining the first position deactivates the gaze tracker.

44. The method according to claim 42, further comprising:
receiving a second gaze activation input from the user to activate the gaze tracker;
defining a second position in the virtual environment based on a second gaze tracker user input;
defining a second working area adjacent the second position as only a part of the virtual environment; returning to the working area; and
operating the virtual environment within the working area only, by the first user input from the at least one input device different from the gaze tracker;
or
operating the virtual environment within the second working area only, by the first user input from the at least one input device different from the gaze tracker.

45. The method according to claim 42, further comprising:
receiving a second gaze activation input from the user to activate the gaze tracker;
receiving an interruption input from the user to deactivate the gaze tracker;
returning to the working area; and
operating the virtual environment within the working area only, by the first user input from the at least one input device different from the gaze tracker.

46. The method according to claim 42, wherein the gaze activation input is received from the at least one input device.

47. The method according to claim 42, wherein a cursor of the virtual environment is moved to within the working area when the first position has been defined.

48. The method according to claim 42, wherein operating the virtual environment comprises at least one of:
moving the cursor within the working area;
scrolling an application window or slide;
zooming an application window or slide;
swiping from a first window or first slide to a second window or second slide;
activating or deactivating checkboxes;
selecting radio buttons;
navigating and selecting from dropdown lists;
navigating and activating and deactivating items from list boxes;
clicking a button (in the virtual environment) or icon;
clicking a menu button or icon;
activating and deactivating toggles;
manipulating text fields;
manipulating windows, fields, and message boxes;
manipulating sliders/track bar and carousels; and/or
activating and deactivating tool tips.

49. The method according to claim 42, wherein at least one movement by a body member is registered by a camera for operating the virtual environment, wherein the body member comprises at least one of:
an eyelid;
a hand;
an arm; and
a leg of the user.

50. The method according to claim 42, wherein different relative movements or different relative positions between a first finger and a second finger of a hand and/or a first finger and a palm of a hand are registered by a wearable device worn by the hand for operating the virtual environment.

51. The method according to claim 50, wherein operating the virtual environment comprises the first finger touching different areas of the second finger or the palm.

52. The method according to claim 47, wherein the cursor is positioned inside the working area in a second position determined by a position of a first body member of the user relative to a coordinate system.

53. The method according to claim 52, wherein the coordinate system is defined by a tracking device, or a first part of a wearable device, or a second body part of the user as seen by a camera.

54. The method according to claim 52, wherein the first body member and/or the second body member is selected from one of:
a finger;
a hand;
a palm;
an arm;
a toe;
a foot;
a leg;
a tongue;
a mouth;
an eye;
a torso; and
a head.

55. The method according to claim 52, wherein the first body member and/or the second body member is/are wearing a wearable device configured to determine a position of the first body member and/or the second body member and/or a relative position of the first body member relative the second body member.

56. The method according to claim 42, further comprising repeating:
receiving the gaze activation input from the user to activate the gaze tracker; and
defining the first position in the virtual environment based on the gaze tracker user input as determined by the gaze tracker to further define a first working area, wherein the first user input operates the virtual environment based on the first working area and the working area.

57. The method according to claim 42, wherein the method further comprises identifying a virtual item within the working area, wherein:
the virtual item is connected to a real item;
an activity is connected to the real item; and
the first user input controls the activity.

58. The method according to 57, wherein the real item is a certain distance from the user, and wherein the virtual item is positioned with a focal length from the user corresponding to, or substantially equal to, the certain distance.

59. The method according to claim 42, wherein operating the virtual environment within the working area only is terminated by a deactivation input received from the user.

60. The method according to claim 42, wherein the gaze activation input is touching or positioning a body member on a trackpad configured to activate the gaze tracker.

61. The method according to claim 49, wherein the gaze activation input is a body member moving into a field-of-view of the camera, or into a certain first volume or first area of the field of view, and wherein the moving body member comprises one of:
a finger;
a hand;
an arm;
a toe;
a foot; and
a leg.

62. The method according to claim 50, wherein a first relative movement or a first relative position of the different relative movements is the gaze activation input.

63. The method according to claim 62, wherein the first relative movement or position of the different relative movements or positions is moving or positioning one finger of the hand wearing the wearable device within a second volume or second area.

64. The method according to claim 42, wherein the gaze activation input is the first finger touching the second finger or the palm at a certain first position.

65. The method according to claim 50, wherein the gaze activation input is:
moving one finger or the first finger of the hand wearing the wearable device within the second volume or second area; or
touching the certain first position twice within a first time period.

66. The method according to claim 42, wherein the gaze activation input is a second signal from an electromyography or a neural and/or muscle activity tracker, and wherein the second signal is a nerve signal or a muscle signal for moving a certain body member.

67. The method according to claim 64, wherein the first time period is:
less than 2 seconds, or less than 1 second, or between 0.2 seconds and 1 second.

68. The method according to claim 42, wherein the gaze activation input comprises one of:
activating a first button of the at least one input device;
touching the at least one input device;
performing an activating movement by a body member wearing a wearable input device, wherein the body member comprises at least one of an arm, a hand, a leg, a foot, and a head; and
performing an activating movement in front of a first camera.

69. The method according to claim 42, wherein defining the first position and/or defining the working area is performed if a duration of touching the at least one input device is longer than 75 ms.

70. The method according to claim 42, wherein a previous working area has already been defined, and wherein method further comprises maintaining the previous working area when a duration of touching the at least one input device is:
less than 75 ms; or
between 35 ms and 75 ms; or
less than 100 ms; or
between 35 ms and 100 ms; or
less than 250 ms; or
between 35 ms and 250 ms.

71. The method according to claim 59, wherein the deactivation input comprises at least one of:
deactivating a first button;
activating the first button a second time;
activating a second button;
un-touching the at least one input device;
touching the at least one input device a second time;
performing a deactivating movement or deactivating position by a body member wearing the wearable device or the wearable input device, wherein the body member comprises at least one of:
an arm;
a hand;
a leg;
a foot; and
a head; and
performing a deactivating movement in front of a first camera.

72. The method according to claim 42, wherein the at least one input device comprises one of:
a mouse;
a trackpad;
a touchscreen;
a trackball;
a thumb stick;
a hand tracker;
a head tracker;
a body tracker;
a trackpoint;
a body member tracker;
a console controller;
a wand controller;
a cross reality (XR) controller; and
a virtual reality (VR) controller.

73. The method according to claim 42, wherein the virtual environment is displayed on a display comprising one of:
an electronic visual display comprising one of:
an XR head-mounted display or glasses;
augmented reality glasses;
augmented reality goggles;
augmented reality contact lenses; and
a head-mountable see-through display;
a see-through electronic visual display;
a user interface of an electronic processing device;
a user interface of a specific application of an electronic processing device; and
a 3D visual display.

74. The method according to claim 42, wherein the working area is visualized to the user in the virtual environment when the working area is defined.

75. The method according to claim 42, wherein the first position is determined by further calculating a second distance between the gaze tracker and eyes of the user.

76. The method according to claim 42, wherein the first position is defined at an instant when:
the gaze activation input is received; or
when the gaze activation input has been received and at least one eye of the user is open.

77. The method according to claim 42, wherein a size or a diameter of the working area is adjustable.

78. The method according to claim 42, wherein a size or a diameter of the working area is adjustable by the user.

79. The method according to claim 42, wherein operating the virtual environment comprises at least one of:
selecting an application or element within the working area;
activating an application or element within the working area;
deactivating an application or element within the working area; and
controlling an application or element within the working area.

80. A data processing system comprising:
an electronic visual display configured to provide a visualization of a virtual environment;
a gaze tracker;
an input device; and
processing circuitry configured to:
receive a gaze activation input from a user to activate the gaze tracker;
define a first position in the virtual environment based on a gaze tracker user input as determined by the gaze tracker;
define a working area adjacent the first position as only a part of the virtual environment; and
operate the virtual environment within the working area only responsive to a first user input from at least one input device different from the gaze tracker.

81. A non-transitory computer readable medium comprising a computer program stored therein, the computer program comprising instructions which, when executed by processing circuitry of a computer connected to a gaze tracker, causes the computer to:
receive a gaze activation input from a user to activate the gaze tracker;
define a first position in the virtual environment based on a gaze tracker user input as determined by the gaze tracker;
define a working area adjacent the first position as only a part of the virtual environment; and
operate the virtual environment within the working area only responsive to a first user input from at least one input device different from the gaze tracker.

82. The computer program according to claim 81, wherein the computer is further connected to:
a tracking device;
a camera associated with operating the virtual environment; and/or
a wearable device; and
wherein the tracking device comprises a trackpad, and wherein the wearable device comprises a dataglove.
